(19) United States
(12) Patent Application Publication
(10) Pub. No.: US 2024/0102967 A1
(43) Pub. Date: Mar. 28, 2024

(54) VIBRATION TEST DEVICE AND VIBRATION TEST METHOD

(71) Applicant: NIPPON TELEGRAPH AND TELEPHONE CORPORATION, Tokyo (JP)

(72) Inventors: Daiki KOBAYASHI, Tokyo (JP); Yuta IKEGUCHI, Tokyo (JP); Daisuke UCHIBORI, Tokyo (JP); Masafumi NAKAGAWA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 17/767,422

(22) PCT Filed: Oct. 8, 2019
(86) PCT No.: PCT/JP2019/039722

§ 371 Date: Apr. 7, 2022

(51) Int. Cl. G01N 29/12; G01N 29/22; G01N 29/24

(52) U.S. Cl. CPC G01N 29/12; G01N 29/223; G01N 29/2418; G01N 2291/014

(57) ABSTRACT

A vibration test device (100) is a vibration test device for testing vibration of a pipeline (10) attached to a structure. The vibration test device includes a plurality of support members (101a, 101b) that are joined to a wall surface with a predetermined gap therebetween and support the pipeline, a first fixing member (102a) that fastens the pipeline to a first support member at a position where one end of the pipeline protrudes from the first support member, a second fixing member (102b) that fastens the pipeline to a second support member at a position where another end of the pipeline protrudes from the second support member, a vibration-applying portion (103) that applies vibration force to one of the support members, a detection unit (104) that detects vibration of the pipeline, and a measurement unit (105) that measures a vibration characteristic of the pipeline.

### TECHNICAL FIELD

The present disclosure relates to a vibration test device and a vibration test method for testing vibration of a pipeline attached to a structure.

### BACKGROUND ART

Conventionally, as shown in FIG. 6, pipeline equipment 200 for infrastructure equipment such as electricity, water, and communication equipment can be provided under a structure such as a bridge 210. In the pipeline equipment 200, a pipeline 10 is supported at a plurality of support points by a beam 220 of the bridge 210, and is fixed at each support point by a fixing member such as a U-shaped bolt 230.

In pipeline equipment, in order to prevent the generation of noise, abnormal stress, or the like in a pipeline caused by resonance with the structure, the support points need to be set at locations where resonance does not occur. For this reason, it is necessary to measure a vibration characteristic (e.g., the natural frequency) of the pipeline based on the distance between support points, the shape of the pipeline, physical properties of the pipeline, and the like, and take such characteristics into account in the design. Because actual pipeline equipment takes various forms depending on the pipeline shape, U-shaped bolt constraint conditions, and the like, it is difficult to calculate the natural frequency of a pipeline on paper. Therefore, it is necessary to measure the vibration of actual equipment or a pipeline that mimics actual equipment.

However, because actual equipment is easily affected by the surrounding environment, pipeline vibration measurement cannot be performed easily. In view of this, a test method that employs a vibration test device has been proposed (e.g., see NPL 1).

### CITATION LIST

### Non Patent Literature

[NPL 1] D. Kobayashi, K. Tanaka, “Examination of resonance of repair FRP pipe attached to a bridge”, Japan Society of Civil Engineers Annual Conference, 2014.

### SUMMARY OF THE INVENTION

### Technical Problem

However, conventional vibration test devices are expensive due to requiring a large hydraulic machine or the like, and furthermore, in terms of specifications, it has been difficult to appropriately change the measurement conditions (e.g., span length and number of spans) according to the mode of the pipeline equipment, and it has been difficult to measure the vibration characteristics of a pipeline before the designing of actual equipment.

The present disclosure was made in view of such circumstances, and an object of the present disclosure is to provide a vibration test device and a vibration test method that are capable of easily reproducing pipeline vibration and measuring a pipeline vibration characteristic before the designing of actual equipment, while also being low-cost.

### Means for Solving the Problem

A vibration test device according to one aspect is a vibration test device for testing vibration of a pipeline attached to a structure, the vibration test device including: a plurality of support members configured to be joined to a wall surface with a predetermined gap therebetween and support the pipeline; a first fixing member configured to fasten the pipeline to a first support member among the plurality of support members, at a position where one end of the pipeline protrudes from the first support member; a second fixing member configured to fasten the pipeline to a second support member among the plurality of support members, at a position where another end of the pipeline protrudes from the second support member; a vibration-applying portion configured to apply vibration force to a support member among the plurality of support members; a detection unit configured to detect vibration of the pipeline; and a measurement unit configured to measure a vibration characteristic of the pipeline.

A vibration test method according to one aspect is a vibration test method for testing vibration of a pipeline attached to a structure, the vibration test method including the steps of: joining a plurality of support members to a wall surface with a predetermined gap therebetween, and supporting the pipeline with the plurality of support members; fastening the pipeline to a first support member among the plurality of support members with use of a first fixing member, at a position where one end of the pipeline protrudes from the first support member; fastening the pipeline to a second support member among the plurality of support members with use of a second fixing member, at a position where another end of the pipeline protrudes from the second support member; applying vibration force to a support member among the plurality of support members with use of a vibration-applying portion; detecting vibration of the pipeline with use of a detection unit; and measuring a vibration characteristic of the pipeline with use of a measurement unit.

### Effects of the Invention

According to the present disclosure, it is possible to provide a vibration test device and a vibration test method that are capable of easily reproducing pipeline vibration and measuring a pipeline vibration characteristic before the designing of actual equipment, while also being low-cost.

### BRIEF DESCRIPTION OF DRAWINGS

FIG. 1 is a top view showing an example of the configuration of a vibration test device according to an embodiment.

FIG. 2A is a diagram showing an example of the mode of a pipeline according to the embodiment.

FIG. 2B is a diagram showing an example of the mode of the pipeline according to the embodiment.

FIG. 3A is a diagram showing an example of the configuration of a support member according to the embodiment.

FIG. 3B is a diagram showing an example of the configuration of the support member according to the embodiment.

FIG. 3C is a diagram showing an example of the configuration of the support member according to the embodiment.

FIG. 3D is a diagram showing an example of the configuration of the support member according to the embodiment.

FIG. 4A is a cross-sectional view showing an example of the configuration of the vibration test device according to the embodiment.

FIG. 4B is a cross-sectional view showing an example of the configuration of the vibration test device according to the embodiment.

FIG. 4C is a cross-sectional view showing an example of the configuration of the vibration test device according to the embodiment.

FIG. 5 is a flowchart showing an example of a vibration test method according to an embodiment.

FIG. 6 is a diagram showing an example of the configuration of pipeline equipment.

### DESCRIPTION OF EMBODIMENTS

Hereinafter, embodiments for carrying out the present invention will be described with reference to the drawings.

<Structure of Vibration Test Device>

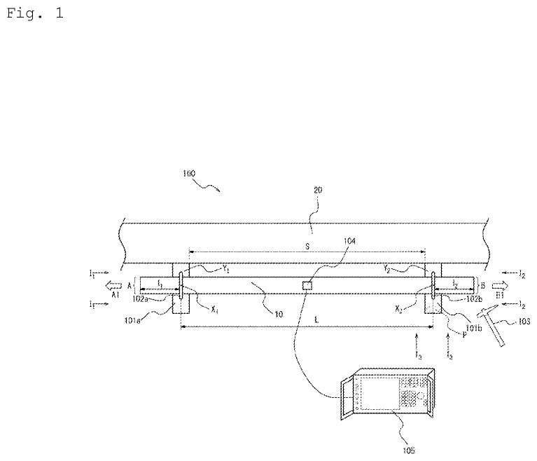

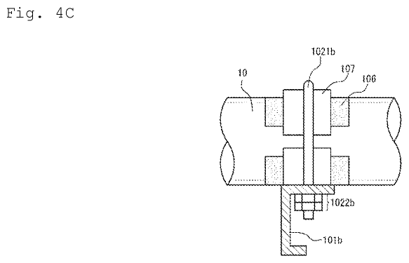

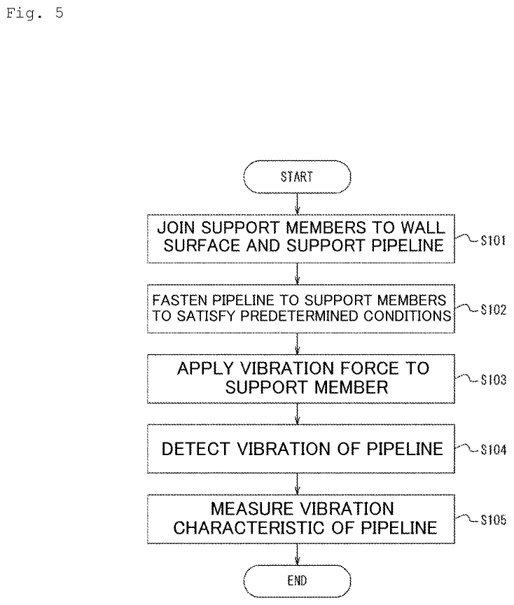

A configuration of a vibration test device 100 according to an embodiment of the present invention will be described below with reference to FIGS. 1 to 4. FIG. 4A is a diagram showing a cross section taken along I₁-I₁ in FIG. 1. FIG. 4B is a diagram showing a cross section taken along I₂-I₂ in FIG. 1. FIG. 4C is a diagram showing a cross section taken along I₃-I₃ in FIG. 1.

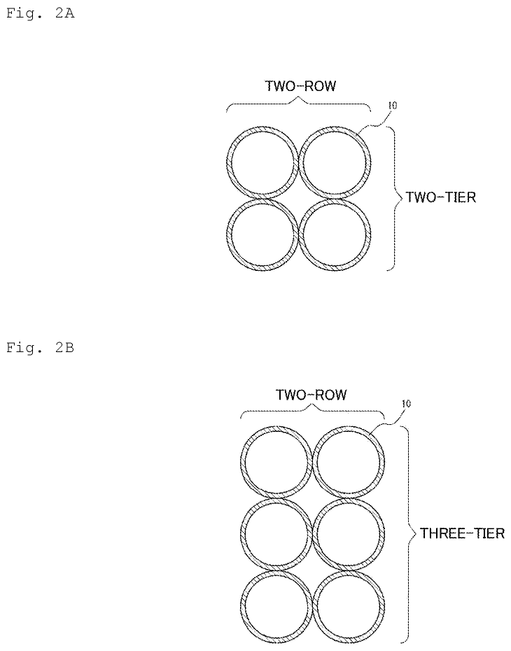

The vibration test device 100 is a device for use in a laboratory, and is for reproducing and measuring vibration in a pipeline attached to a structure. A pipeline 10 is a pipe made of resin or metal, and is a hard vinyl pipe, an FRP (Fiber Reinforced Plastics) pipe, a steel pipe, an FRPM (Fiberglass Reinforced Plastic Mortar) pipe, or the like. Note that although FIG. 1 shows the case where one pipeline 10 is disposed in the vibration test device 100 as an example, there are no particular limitations on the mode of the pipeline 10 disposed in the vibration test device 100. For example, pipelines may be disposed in a two-row two-tier mode (see FIG. 2A) or a two-row three-tier mode (see FIG. 2B) in the vibration test device 100 to mimic the layout mode of actual pipeline equipment. Also, the pipeline 10 is not particularly limited in terms of diameter and material as long as it has a cylindrical shape, and it may be provided with a joint or the like and have protrusions/recessions.

FIG. 1 is a view seen from the ceiling, with the exception of a measurement unit 105. The vibration test device 100 is attached to a wall surface 20 that extends in a direction perpendicular to the ground. The pipeline 10 is disposed in the vibration test device 100 so as to be parallel to the ground. Note that the wall surface 20 may be a wall surface used in a general building, and there are no particular limitations on the material or the like.

The vibration test device 100 includes support members 101a and 101b, fixing members 102a and 102b, a vibration-applying portion 103, a detection unit 104, and a measurement unit 105.

The support members 101a and 101b are joined to the wall surface 20 with a predetermined gap S therebetween. The wall surface 20 and the support members 101a and 101b are joined by a known method such as bolting, welding, or adhesion. The operator can appropriately adjust the gap S between the support member 101a and the support member 101b.

The support member (first support member) 101a supports the pipeline 10 at a support point (first support point) X₁ on the support member 101a. The support member 101a supports the pipeline 10 at the support point X1 on the support member 101a, which is at a position where one end A of the pipeline 10 protrudes in the direction of an arrow A1. The support member 101a is provided with through holes H for insertion of the fixing member 102a.

The support member (second support member) 101b supports the pipeline 10 at a support point (second support point) X₂ on the support member 101b. The support member 101b supports the pipeline 10 at the support point X2 of the support member 101b, which is at a position where another end B of the pipeline 10 protrudes in the direction of an arrow B1. The support member 101b is provided with through holes H for insertion of the fixing member 102b.

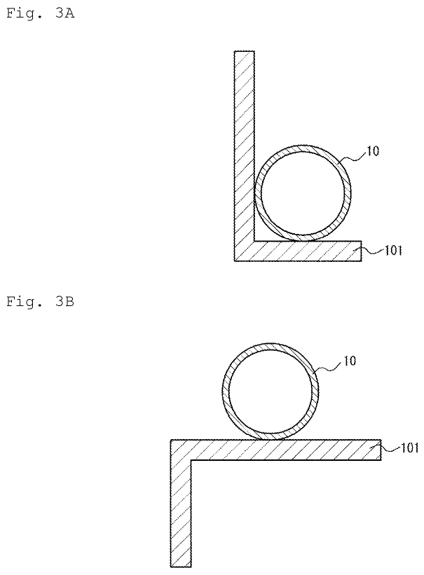

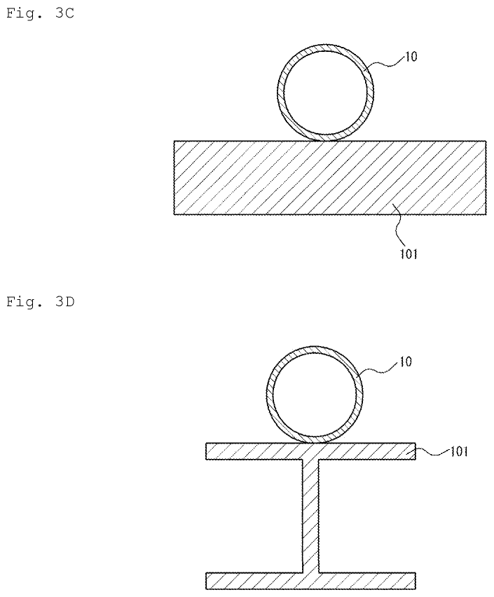

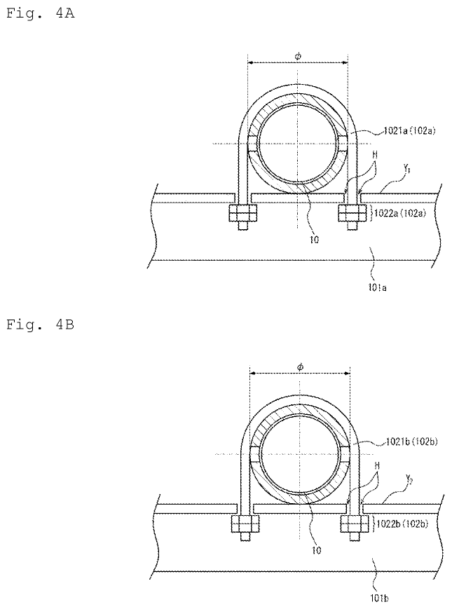

The support members 101a and 101b may have a configuration in which the surface on which the pipeline 10 is disposed is flat and can stably support the pipeline 10. The support members 101a and 101b may be made of an L-shaped steel member, for example, as shown in FIG. 3A or FIG. 3B. The support members 101a and 101b may be made of a flat steel member, for example, as shown in FIG. 3C. The support members 101a and 101b may be made of an H-shaped steel member, for example, as shown in FIG. 3D.

The distance between the support point X₁ and the support point X₂ is called the span length. The operator can appropriately change the span length by adjusting the gap S between the support member 101a and the support member 101b. For example, if the pipeline 10 is a hard vinyl pipe, the operator can set the span length to L=2.5 m. As another example, if the pipeline 10 is an FRP pipe, the operator can set the span length to L=5.0 m.

The number of sections between support points in the pipeline 10 supported by a plurality of support members is called the number of spans. The operator can appropriately change the number of spans by adjusting the number of support members 101 and the positions where the support members 101 are joined to the wall surface 20.

The vibration-applying portion 103 is used to apply vibration force to a vibration point P on the support member 101a or 101b. For example, when an operator hits the vibration point P using the vibration-applying portion 103, impact vibration force is applied to the vibration point P. The support member 101a or 101b vibrates based on the applied vibration force. The vibration of the support member 101a or 101b is transmitted to the pipeline 10. Note that although the vibration point P is set at a predetermined position on the support member 101b in FIG. 1, it may be set at a predetermined position on the support member 101a. Regardless of whether the vibration point P is set on the support member 101a or the support member 101b, it is preferable to set the vibration point P at a position where the accuracy of vibration measurement can be improved.

The fixing members 102a and 102b fasten the pipeline 10 to the support members 101a and 101b. The fixing member (first fixing member) 102a fastens the pipeline 10 to the support member 101a at a position where the one end A of the pipeline 10 protrudes from the support member 101a. The fixing member (second fixing member) 102b fastens the pipeline 10 to the support member 101b at a position where the other end B of the pipeline 10 protrudes from the support member 101b.

Specifically, the fixing member 102a fastens the pipeline 10 to the support member 101a at a position where a distance l₁ between the one end A of the pipeline 10 and the support point X₁ is less than or equal to 20% of a distance L between the support point X₁ and the support point X₂ (l₁≤0.2L).

Specifically, the fixing member 102b fastens the pipeline 10 to the support member 101b at a position where a distance l₂ between the other end B of the pipeline 10 and the support point X₂ is less than or equal to 20% of the distance L between the support point X₁ and the support point X₂ (l₂≤0.2L).

The pipeline 10 is fastened to the support members 101a and 101b by the fixing members 102a and 102b at positions where the distance l₁ between the one end A of the pipeline 10 and the support point X₁ is less than or equal to 20% of the distance L between the support point X₁ and the support point X₂, and where the distance l₂ between the other end B of the pipeline 10 and the support point X₂ is less than or equal to 20% of the distance L between the support point X₁ and the support point X₂, and therefore it is possible to prevent the pipeline 10 from bending a large amount outward of the fixing members 102a and 102b in the vibration test device 100.

The fixing member 102a includes a U-shaped bolt 1021a and nuts 1022a (see FIG. 4A), for example. The fixing member 102b includes a U-shaped bolt 1021b and nuts 1022b (see FIGS. 4B and 4C), for example.

The U-shaped bolts 1021a and 1021b are each a single steel member that has a curved central portion and a bolt structure at the two end portions. The U-shaped bolts 1021a and 1021b are attached to the support members 101a and 101b so as to sandwich the pipeline 10, and the end portions are inserted into the through holes H provided in the support members 101a and 101b.

The nuts 1022a and 1022b have a structure in which the outer diameter is one size larger than the outer diameter of the through holes. The nuts 1022a and 1022b are screwed to the end portions of the U-shaped bolts 1021a and 1021b so as to sandwich the pipeline 10 and the support members 101a and 101b on the side opposite to support surfaces Y₁ and Y₂ of the support members 101a and 101b. Accordingly, the pipeline 10 is fastened to the support members 101a and 101b by the fixing members 102a and 102b.

In the case where the fixing member 102a includes the U-shaped bolt 1021a, the fixing member 102a fastens the pipeline 10 to the support member 101a at a position where the distance l₁ between the one end A of the pipeline 10 and the support point X₁ is greater than or equal to the outer diameter φ of the pipeline 10 (l₁≥φ).

In the case where the fixing member 102b includes the U-shaped bolt 1021b, the fixing member 102b fastens the pipeline 10 to the support member 101b at a position where the distance l₂ between the other end B of the pipeline 10 and the support point X₂ is greater than or equal to the outer diameter φ of the pipeline 10 (l₂≥φ).

The pipeline 10 is fastened to the support members 101a and 101b by the fixing members 102a and 102b at positions where the distance l₁ between the one end A of the pipeline 10 and the support point X₁ is greater than or equal to the outer diameter φ of the pipeline 10, and where the distance l₂ between the other end B of the pipeline 10 and the support point X₂ is greater than or equal to the outer diameter φ of the pipeline 10. According to this configuration, in the vibration test device 100, the boundary conditions between the pipeline 10 and the support members 101a and 101b and the fixing members 102a and 102b can be set so as to accurately match the boundary conditions between the pipeline and a bridge beam and U-shaped bolts in actual equipment. This makes it possible to reproduce the boundary conditions between the pipeline and a bridge beam and U-shaped bolts in actual equipment, and therefore vibration that mimics the vibration generated in a pipeline that resonates with a bridge on which vehicles travel, for example, can be realistically reproduced by the operator while remaining in the laboratory.

Note that if the pipeline 10 is fastened to the support members 101a and 101b by the fixing members 102a and 102b at positions where the distance l₁ between the one end A of the pipeline 10 and the support point X₁ is smaller than the outer diameter φ of the pipeline 10, and where the distance l₂ between the other end B of the pipeline 10 and the support point X₂ is smaller than the outer diameter φ of the pipeline 10, the boundary conditions between the pipeline 10 and the support members 101a and 101b and the fixing members 102a and 102b become fixed support boundary conditions. In this case, it is not possible to reproduce the boundary conditions between the pipeline and a bridge beam and U-shaped bolts in actual equipment.

As shown in FIG. 4, protective pieces 107 adhered using an adhesive 106 may be provided between the pipeline 10 and the fixing members 102a and 102b. If the protective pieces 107 are provided between the pipeline 10 and the fixing members 102a and 102b, the pipeline 10 can be protected when the pipeline 10 is fastened to the support members 101a and 101b by the fixing members 102a and 102b.

The vibration-applying portion 103 applies vibration force to the support member 101a or 101b. The vibration-applying portion 103 may apply vibration force to a predetermined position on the support member 101a, or may apply vibration force to a predetermined position on the support member 101b.

The vibration-applying portion 103 is a rubber hammer, for example. When the operator hits the vibration point P with the rubber hammer for example, impact vibration force is applied to the vibration point P. There are no particular limitations on the mode of the vibration-applying portion 103, but using a rubber hammer makes it possible to prevent the vibration test device 100 from being damaged, and the operator can easily apply vibration force to the support member 101a or the support member 101b. Also, using a rubber hammer as the vibration-applying portion 103 makes it possible to reduce noise in the measured values.

When the vibration-applying portion 103 applies vibration force to the vibration point P, the support member 101a or 101b vibrates, and the vibration of the support member 101a or 101b is transmitted to the pipeline 10. Note that the vibration-applying portion 103 may include a sensor unit capable of wireless communication with the measurement unit 105, for example. In this case, the sensor unit detects the vibration force applied to the support member 101a or 101b and outputs various data at the time of impact vibration to the measurement unit 105, and thus the measurement unit 105 can take such data into consideration in order to measure the vibration characteristic of the pipeline 10 with higher accuracy.

The detection unit 104 detects vibration of the pipeline 10 and outputs a detection result to the measurement unit 105. The detection unit 104 is a contact-type acceleration sensor, a contactless laser Doppler vibrometer, or the like. As shown in FIG. 1, if the detection unit 104 is an acceleration sensor, the acceleration sensor is provided in a central portion of the pipeline 10 and detects vibration of the pipeline 10. If the detection unit 104 is a laser Doppler vibrometer, the laser Doppler vibrometer is provided at a predetermined distance (e.g., 2 m) from the vibration test device 100 and detects vibration of the pipeline 10 by irradiating a central portion of the pipeline 10 with a laser beam and converting the change in the frequency of the Doppler-shifted reflected laser light into a voltage.

The measurement unit 105 measures a vibration characteristic of the pipeline 10 based on the detection result received from the detection unit 104. The measurement unit 105 is an FFT (Fast Fourier Transform) analyzer for example, and measures the natural frequency of the pipeline 10. Note that the measurement unit 105 is not limited to being connected to the detection unit 104 by a wire as shown in FIG. 1, and may be configured to perform wireless communication with the measurement unit 105.

Based on the measurement result obtained by the measurement unit 105, the operator can understand whether or not the pipeline 10 is safe with respect to resonance with the bridge due to traffic vibration in the pipeline equipment, for example. In other words, the operator can be made aware of information acquired based on vibration of the pipeline 10 reproduced by the vibration test device 100 (a vibration characteristic of the pipeline 10) before the designing of actual equipment, and can take such information into account when designing the pipeline equipment.

In the vibration test device 100 according to the present embodiment, the pipeline 10 is fastened to the support members 101a and 101b by the fixing members 102a and 102b at positions where the distance l₁ between the one end A of the pipeline 10 and the support point X₁ is less than or equal to 20% of the distance L between the support point X₁ and the support point X₂, and where the distance l₂ between the other end B of the pipeline 10 and the support point X₂ is less than or equal to 20% of the distance L between the support point X₁ and the support point X₂. Accordingly, it is possible to realize a vibration test device 100 capable of easily reproducing pipeline vibration and measuring a pipeline vibration characteristic before the designing of actual equipment, while also being low-cost.

Also, in the vibration test device 100 according to the present embodiment, measurement conditions such as the span length and the number of spans can be appropriately changed according to the mode of the pipeline equipment. Accordingly, the operator can carry out desired testing without worrying about the restrictions in terms of device specifications.

<Vibration Test Method>

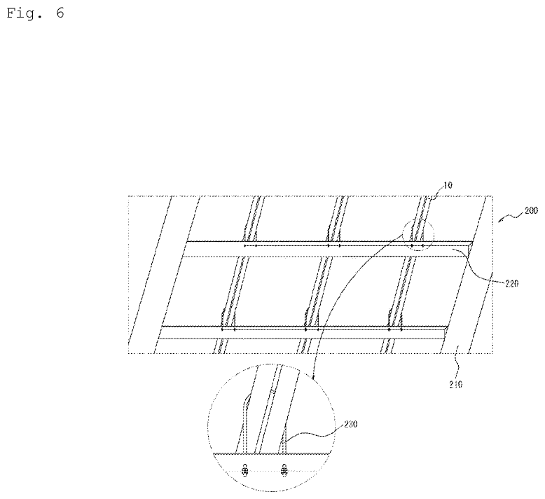

Next, a vibration test method according to an embodiment of the present invention will be described with reference to FIG. 5.

In step S101, the support members 101a and 101b are joined to the wall surface 20 with the predetermined gap S therebetween, the support member 101a supports the pipeline 10 at the support point X₁ of the support member 101a, and the support member 101b supports the pipeline 10 at the support point X₂ of the support member 101b.

In step S102, the fixing members 102a and 102b fasten the pipeline 10 to the support members 101a and 101b. The fixing member 102a fastens the pipeline 10 to the support member 101a at a position where the distance l₁ between the one end A of the pipeline 10 and the support point X₁ is less than or equal to 20% of the distance L between the support point X₁ and the support point X₂ (l₁≤0.2L). The fixing member 102b fastens the pipeline 10 to the support member 101b at a position where the distance l₂ between the other end B of the pipeline 10 and the support point X₂ is less than or equal to 20% of the distance L between the support point X₁ and the support point X₂ (l₂≤0.2L).

In step S103, the vibration-applying portion 103 applies vibration force to the support member 101a or 101b. When the operator hits the vibration point P with the rubber hammer for example, impact vibration force is applied to the vibration point P. When the vibration-applying portion 103 applies vibration force to the vibration point P, the support member 101a or 101b vibrates, and the vibration of the support member 101a or 101b is transmitted to the pipeline 10.

In step S104, the detection unit 104 detects vibration of the pipeline 10. For example, if the detection unit 104 is an acceleration sensor, the acceleration sensor is provided in a central portion of the pipeline 10 and detects vibration of the pipeline 10 over time.

In step S105, the measurement unit 105 measures a vibration characteristic of the pipeline 10. The measurement unit 105 is an FFT (Fast Fourier Transform) analyzer for example, and measures the natural frequency of the pipeline 10. Experiments have shown that particularly good results are obtained in the case where the pipeline 10 is a hard vinyl pipe that has a nominal diameter of 75 mm.

In the vibration test method according to the present embodiment, the fixing members 102a and 102b fasten the pipeline 10 to the support members 101a and 101b at positions where l₁≤0.2L and l₂≤0.2L. Accordingly, it is possible to realize a vibration test method capable of easily reproducing pipeline vibration and measuring a pipeline vibration characteristic before the designing of actual equipment, while also being low-cost.

Although the above embodiments have been described as representative examples, it will be apparent to those skilled in the art that many modifications and substitutions can be made within the spirit and scope of the present disclosure. Accordingly, the present invention should not be construed as being limited by the above embodiments, and various modifications and modifications can be made without departing from the claims. Also, a plurality of the steps described in the flowchart of the embodiment may be combined into one step, or a step may be divide into a plurality of steps.

For example, in the present embodiment, a configuration in which the pipeline 10 is disposed in the vibration test device 100 so as to be parallel to the ground has been described as an example, but the present invention is not limited to this. The pipeline 10 may be disposed in the vibration test device 100 so as to be perpendicular to the ground.

Also, in the present embodiment, a configuration in which the vibration test device 100 is attached to the wall surface 20 has been described as an example, but the present invention is not limited to this. The vibration test device 100 may be mounted on the ceiling surface, for example.

Also, in the present embodiment, a configuration in which the vibration test device includes two support members 101 has been described as an example, but the number of support members 101 is not limited to this. It is sufficient that there are a plurality of support members 101, and the number thereof may be three or more.

Also, in the present embodiment, a configuration in which the vibration test device includes two fixing members 102 has been described as an example, but the number of fixing members 102 is not limited to this. It is sufficient that there are a plurality of fixing members 102, and the number thereof may be three or more.

Also, in the present embodiment, configurations in which the detection unit 104 is a contact-type acceleration sensor or a contactless laser Doppler vibrometer have been described as examples, but the detection unit 104 is not limited to this.

### REFERENCE SIGNS LIST

10 Pipeline
20 Wall surface
100 Vibration test device
101a Support member (first support member)
101b Support member (second support member)
102a Fixing member (first fixing member)
102b Fixing member (second fixing member)
103 Vibration-applying portion
104 Detection unit
105 Measurement unit
106 Adhesive
107 Protective piece
1021 U-shaped bolt
1022 Nut

1. A vibration test device for testing vibration of a pipeline attached to a structure as a conduit, the vibration test device comprising:
a plurality of support members configured to be joined to a wall surface with a predetermined gap therebetween and support the pipeline;
a first fixing member configured to fasten the pipeline to a first support member among the plurality of support members, at a position where one end of the pipeline protrudes from the first support member;
a second fixing member configured to fasten the pipeline to a second support member among the plurality of support members, at a position where another end of the pipeline protrudes from the second support member;
a vibration-applying portion configured to apply vibration force to a support member among the plurality of support members;
a detection member configured to detect vibration of the pipeline; and
a measurement member configured to measure a vibration characteristic of the pipeline.

2. The vibration test device according to claim 1,
wherein a distance between the one end of the pipeline and a first support point at which the first support member supports the pipeline and a distance between the other end of the pipeline and a second support point at which the second support member supports the pipeline are each less than or equal to 20% of a distance between the first support point and the second support point.

3. The vibration test device according to claim 1,
wherein the first fixing member and the second fixing member each include a U-shaped bolt and a nut, and
a distance between the one end of the pipeline and a first support point at which the first support member supports the pipeline and a distance between the other end of the pipeline and a second support point at which the second support member supports the pipeline are each greater than or equal to an outer diameter of the pipeline.

4. The vibration test device according to claim 1,
wherein the pipeline is a pipe made of a resin or a metal.

5. The vibration test device according to claim 1,
wherein the plurality of support members are each an L-shaped steel member, a flat steel member, or an H-shaped steel member.

6. A vibration test method for testing vibration of a pipeline attached to a structure, the method comprising:
joining a plurality of support members to a wall surface with a predetermined gap therebetween, and supporting the pipeline with the plurality of support members;
fastening the pipeline to a first support member among the plurality of support members with use of a first fixing member, at a position where one end of the pipeline protrudes from the first support member;
fastening the pipeline to a second support member among the plurality of support members with use of a second fixing member, at a position where another end of the pipeline protrudes from the second support member;
applying vibration force to a support member among the plurality of support members with use of a vibration-applying portion;
causing detecting vibration of the pipeline; and
causing measuring a vibration characteristic of the pipeline unit.

7. The vibration test device according to claim 1, wherein the vibration-applying portion includes a rubber hammer preventing causing a damage to the support bases.

8. The vibration test device according to claim 1, wherein the detection member includes an acceleration sensor at a center portion of the pipeline.

9. The vibration test device according to claim 1, wherein the detection member includes a laser Doppler vibrometer placed at least a predetermined distance away from the pipeline.

10. The vibration test device according to claim 1, wherein the measurement member includes a Fast Fourier Transform analyzer configured to analyze a natural frequency of the pipeline.

11. The vibration test device according to claim 1, wherein the pipeline forms a cylindrical shape.

12. The vibration test device according to claim 1, wherein a number of sections formed between the plurality of support members is adjustable.

13. The vibration test device according to claim 2,
wherein the first fixing member and the second fixing member each include a U-shaped bolt and a nut, and
a distance between the one end of the pipeline and a first support point at which the first support member supports the pipeline and a distance between the other end of the pipeline and a second support point at which the second support member supports the pipeline are each greater than or equal to an outer diameter of the pipeline.

14. The vibration test device according to claim 2, wherein the pipeline is a pipe made of a resin or a metal.

15. The vibration test method according to claim 6, wherein a distance between the one end of the pipeline and a first support point at which the first support member supports the pipeline and a distance between the other end of the pipeline and a second support point at which the second support member supports the pipeline are each less than or equal to 20% of a distance between the first support point and the second support point.

16. The vibration test method according to claim 6, wherein the first fixing member and the second fixing member each include a U-shaped bolt and a nut, and
a distance between the one end of the pipeline and a first support point at which the first support member supports the pipeline and a distance between the other end of the pipeline and a second support point at which the second support member supports the pipeline are each greater than or equal to an outer diameter of the pipeline.

17. The vibration test method according to claim 6,
wherein the pipeline is a pipe made of a resin or a metal.

18. The vibration test method according to claim 6,
wherein the plurality of support members are each an L-shaped steel member, a flat steel member, or an H-shaped steel member.

19. The vibration test method according to claim 6,
wherein the detection member includes an acceleration sensor at a center portion of the pipeline.

20. The vibration test method according to claim 6,
wherein the detecting uses a laser Doppler vibrometer placed at least a predetermined distance away from the pipeline, and
wherein the measuring uses a Fast Fourier Transform analyzer configured to analyze a natural frequency of the pipeline.
